(19) United States
(12) Patent Application Publication
(10) Pub. No.: US 2012/0261964 A1
(43) Pub. Date: Oct. 18, 2012

(54) VEHICLE SEAT

(75) Inventors: Takao YAMAGUCHI, Toyota-shi (JP); Yoshiyuki KUMAZAKI, Aichi-gun (JP)

(73) Assignee: TOYOTA BOSHOKU KABUSHIKI KAISHA, Aichi-ken (JP)

(21) Appl. No.: 13/429,550

(22) Filed: Mar. 26, 2012

(30) Foreign Application Priority Data
Apr. 13, 2011 (JP) 2011-089187
Apr. 13, 2011 (JP) 2011-089202

(51) Int. Cl. B60N 2/20

(52) U.S. Cl. 297/378.14; 297/378.1

(57) ABSTRACT

A vehicle seat is configured such that a seat back is able to be tilted forward from a normal mode in which a person is able to be seated to a walk-in mode in which a person is able to get into and out of a rear seat. In the walk-in mode, the seat back is in a folded-down position in which the seat back substantially lies on top of a seat cushion.

### INCORPORATION BY REFERENCE

The disclosure of Japanese Patent Applications No. 2011-089187 filed on Apr. 13, 2011 and No. 2011-089202 filed on Apr. 13, 2011 including the specification, drawings and abstract is incorporated herein by reference in its entirety.

### BACKGROUND OF THE INVENTION

1. Field of the Invention

The invention relates to a vehicle seat.

2. Description of Related Art

A vehicle seat is known in which a seat back is able to be tilted forward from a normal mode in which a person is able to be seated to a walk-in mode in which a person is able to get into and out of a rear seat. Here, Japanese Patent Application Publication No. 2009-6931 (JP 2009-6931 A) describes a vehicle seat in which, in a walk-in mode, a seat back is in a forward-tilted position with respect to a seat cushion. This enables a person to get into and out of a rear seat with greater ease. In addition, with the vehicle seat described in JP 2009-6931 A, it is also possible to switch from a normal mode that enables a person to sit down to a mode in which the seat back is in a folded-down position in which it substantially lies on top of the seat cushion (i.e., a luggage mode). In this folded-down position, the seat back is locked with respect to the seat cushion, thus enabling luggage or the like to be stably placed on the back of the folded-down seat back.

However, with the technology described in JP 2009-6931 A, for example, when a person who is seated, or who will be seated, in the rear seat is large, simply tilting the seat back forward may not be enough to get the seat back out of the way of this person when he or she gets into and out of the rear seat. Also, when the seat back is folded down, the seat back is locked with respect to the seat cushion. Therefore, when returning the seat back to the normal mode, it must be unlocked, which is inconvenient.

### SUMMARY OF THE INVENTION

The invention thus provides a vehicle seat that further increases the ease with which a person is able to get into and out of the rear seat. The invention also provides a vehicle seat that makes it easy to return a seat back, even when returning a seat back that has been folded down, to a normal mode.

A first aspect of the invention relates to a vehicle seat which is provided with a recliner and a slide lock mechanism, and in which a seat back is able to be tilted forward from a normal mode in which a person is able to be seated to a walk-in mode in which a person is able to get into and out of a rear seat. In the walk-in mode, the seat back is in a folded-down position in which the seat back substantially lies on top of a seat cushion. According to this structure, even if a person that is seated, or will be seated, in the rear seat is large, the seat back is less apt to get in the way when the person gets into and out of the rear seat. Accordingly, a person is able to get into and out of the rear seat with greater ease.

Also, the vehicle seat may be configured to enable the walk-in mode in which a seat slide is unlocked, and a luggage mode in which the seat slide is locked, to be selected. According to this structure, the occupant can select either the walk-in mode or the luggage mode depending on the intended use.

Further, the vehicle seat described above may include a first switching portion, a second switching portion, a first cable operating link, a second cable operating link, a recliner release operating plate, and a slide release link. In the walk-in mode, operation of the first switching portion causes the first cable operating link and the second operating link to rotate. The rotation of the first cable operating link causes the recliner release operating plate to also rotate. The rotation of this recliner release operating plate switches the recliner from a locked state to an unlocked state. When the recliner is unlocked and the seat back tilts forward, the slide release link rotates in conjunction with the forward tilting of the seat back. The rotation of the slide release link switches the slide lock mechanism from a locked state to an unlocked state. In the luggage mode, operation of the second switching portion causes the recliner release operating plate to rotate. The rotation of the recliner release operating plate switches the recliner from a locked state to an unlocked state. When the recliner is unlocked and the seat back tilts forward, the slide lock mechanism remains locked. According to this structure, the arrangement of the seat can be carried out with a simple structure.

A second aspect of the invention relates to a vehicle seat which is provided with a recliner and a slide lock mechanism, and in which a seat back is switched from a normal mode in which a person is able to be seated to a mode in which the seat back is in a folded-down position in which the seat back substantially lies on top of a seat cushion. This vehicle seat includes a first switching portion and a second switching portion. If a switching operation of either one of the switching portions is performed, the recliner will unlock and the seat back will switch from the normal mode to the mode in which the seat back is in a folded-down position. When the first switching portion is operated and the seat back switches from the normal mode to the mode in which the seat back is in a folded-down position, the recliner remains unlocked. When the second switching portion is operated and the seat back switches from the normal mode to the mode in which the seat back is in a folded-down position, the recliner is locked. According to this structure, there is no need to unlock the recliner when returning the folded-down seat back to the normal mode when switching with the first switching portion, so the seat back is able to be easily returned.

Further, the vehicle seat according to the second aspect may be configured such that operation of the first switching portion causes the seat back to switch to the folded-down position in the walk-in mode in which a seat slide is unlocked, and operation of the second switching portion causes the seat back to switch to the folded-down position in a luggage mode in which the seat slide is locked. According to this structure, usability of the vehicle seat can be further improved by selecting the walk-in mode to quickly return the seat back.

Further, the vehicle seat according to the second aspect may also include a first cable operating link, a second cable operating link, a recliner release operating plate, and a slide release link. In the walk-in mode, operation of the first switching portion causes the first cable operating link and the second operating link to rotate. The rotation of the first cable operating link causes the recliner release operating plate to also rotate. The rotation of this recliner release operating plate switches the recliner from a locked state to an unlocked state. When the recliner is unlocked and the seat back tilts forward, the slide release link rotates in conjunction with the forward tilting of the seat back. The rotation of the slide release link switches the slide lock mechanism from a locked state to an unlocked state. In the luggage mode, operation of the second switching portion causes the recliner release operating plate to rotate. The rotation of the recliner release operating plate switches the recliner from a locked state to an unlocked state. When the recliner is unlocked and the seat back tilts forward, the slide lock mechanism remains locked. According to this structure, the arrangement of the seat can be carried out with a simple structure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a frame inside of a passenger seat according to an example embodiment of the invention;

FIG. 2 is an exploded perspective view of a recliner of the passenger seat in FIG. 1;

FIG. 3A to 3J are views each of which shows a frame format of movement of the passenger seat in FIG. 1;

FIG. 4 is a sectional view taken along line IV-IV in FIG. 1;

FIG. 5 is a side view showing a frame format of the main portions of the passenger seat in FIG. 1 in a normal position before being switched to a walk-in position;

FIG. 6 is a view of a state in which a walk-in lever for switching the passenger seat to the walk-in position has been operated;

FIG. 7 is a view of a state in the middle of a switch to the walk-in position;

FIG. 8 is a view of a state after the switch to the walk-in position is complete;

FIG. 9 is a side view of a frame format of the passenger seat in FIG. 1 in a normal position before being switched to a folded-down position;

FIG. 10 is a view of a state in which a strap for switching the passenger seat to the folded-down position has been operated;

FIG. 11 is a view of a state in the middle of a switch to the folded-down position; and

FIG. 12 is a view of a state after the switch to the folded-down position is complete.

### DETAILED DESCRIPTION OF EMBODIMENTS

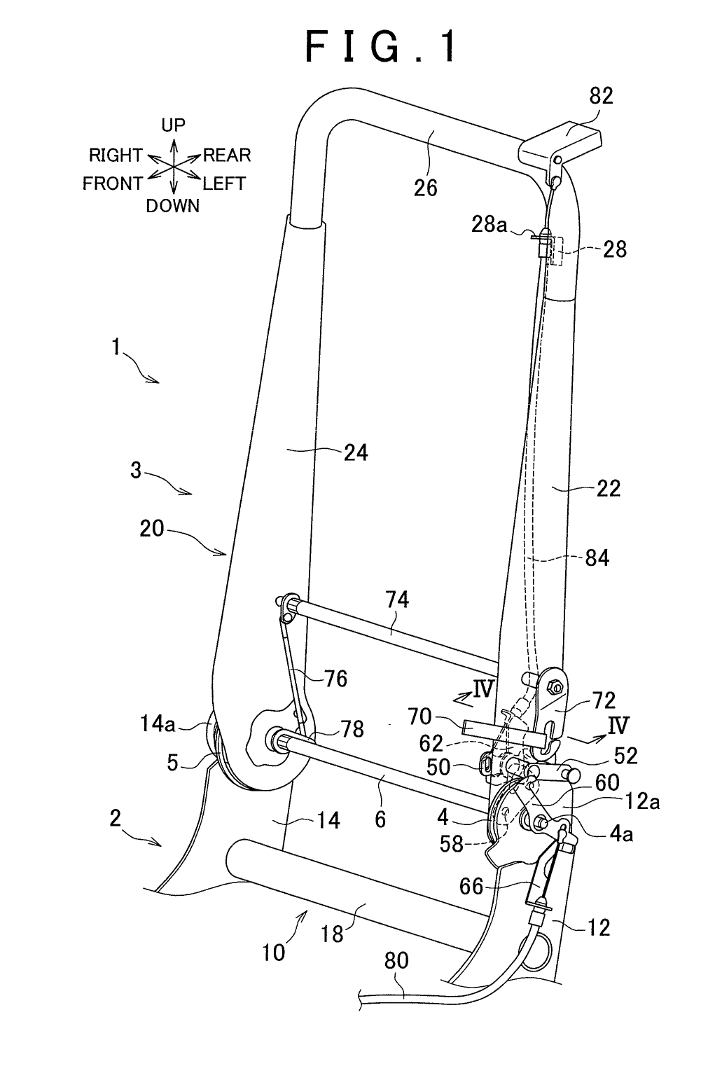

Hereinafter, example embodiments of the invention will be described with reference to FIGS. 1 to 12. In the description below, a passenger seat 1 when there is a rear seat (not shown) is described as an example of the vehicle seat. Also in the description below, the terms up, down, front, rear (or back), left, and right indicate the directions of up, down, front, rear (or back), left, and right in the drawings, i.e., the directions of up, down, front, rear (or back), left, and right with respect to the passenger seat 1.

First, the general structure of the passenger seat 1 according to the example embodiment of the invention will be described with reference to FIGS. 1 to 5. As shown in FIG. 1, this passenger seat 1 mainly includes a seat cushion 2 and a seat back 3. The seat back 3 is mounted to the seat cushion 2 via a pair of left and right recliners 4 and 5. Only a portion of a cushion frame 10 that forms the seat cushion 2, and a back frame 20 that forms a seat back 30 are shown in FIG. 1.

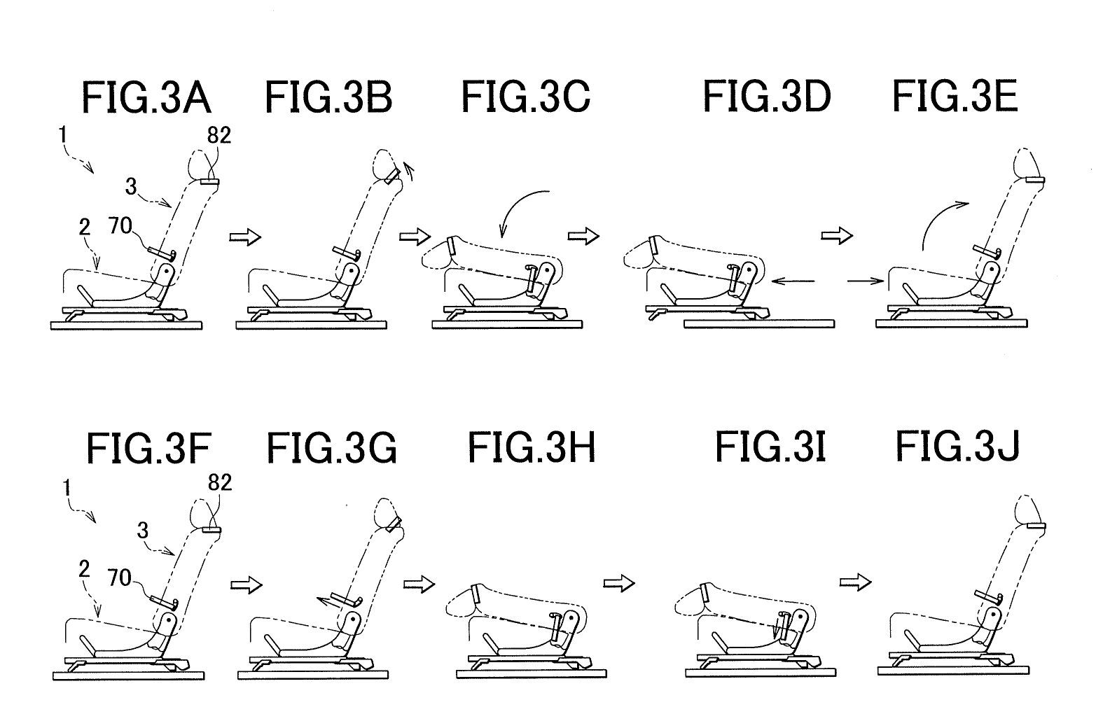

In a normal mode, the left and right recliners 4 and 5 enable the tilt angle of the seat back 3 with respect to the seat cushion 2 to be adjusted as appropriate. The normal mode is a mode (i.e., a state) in which the seat back 3 is in a rearward-tilted position that enables an occupant to be seated (FIGS. 3A and 3F).

Also, left and right recliners 4 and 5 enable the vehicle seat to be switched from the normal mode to a walk-in mode or a luggage mode. The walk-in mode is a mode (i.e., a state) in which the seat back 3 is in a folded-over position in which it substantially lies on top of the seat cushion 2, thus enabling a person to get into and out of the rear seat (FIG. 3D). The luggage mode is a mode (i.e., a state) in which the seat back 3 is in a folded-over position in which it substantially lies on top of the seat cushion 2, similar to the walk-in mode, thus enabling the back of the seat back 3 to be used as a surface on which to put luggage or the like (FIG. 31).

Below, the seat cushion 2, the seat back 3, and the left recliner 4 will each be described separately. The right recliner 5 is the same as the left recliner 4, so a detailed description thereof will be omitted.

First the seat cushion 2 will be described. This seat cushion 2 mainly includes the cushion frame 10, a cushion pad (not shown) that wraps around the cushion frame 10, and a cover (also not shown) that covers the surface of the cushion pad.

The cushion frame 10 is formed in a generally rectangular shape from a left side frame 12 that has a lower arm 12a, a right side frame 14 that has a lower arm 14a, a front rod (not shown) that extends between the front ends of the side frames 12 and 14, and a rear rod 18 that extends between the rear ends of the side frames 12 and 14.

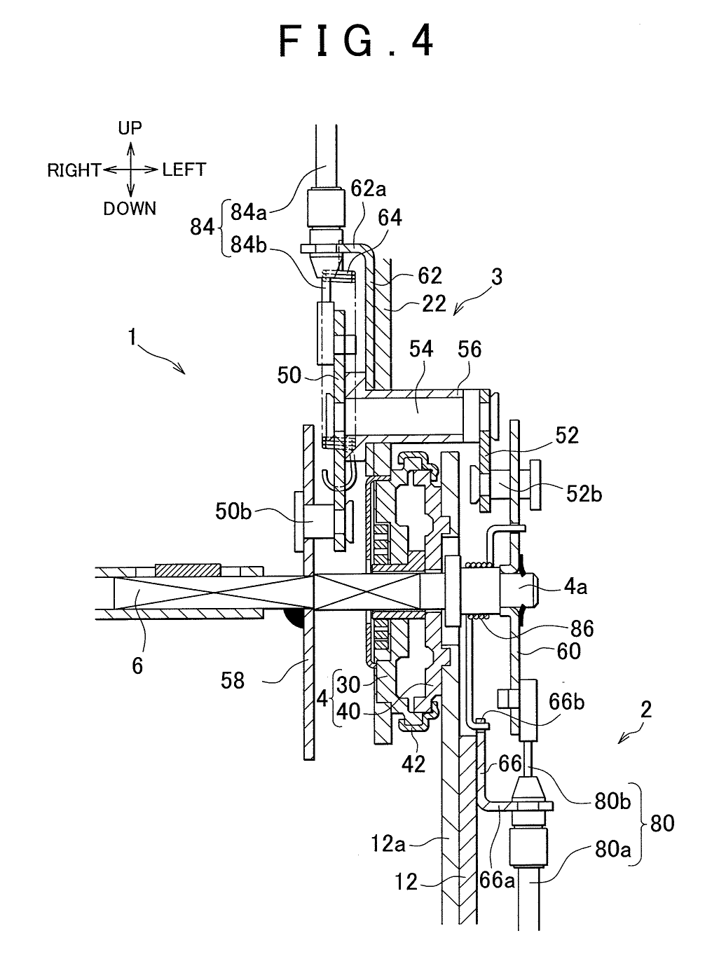

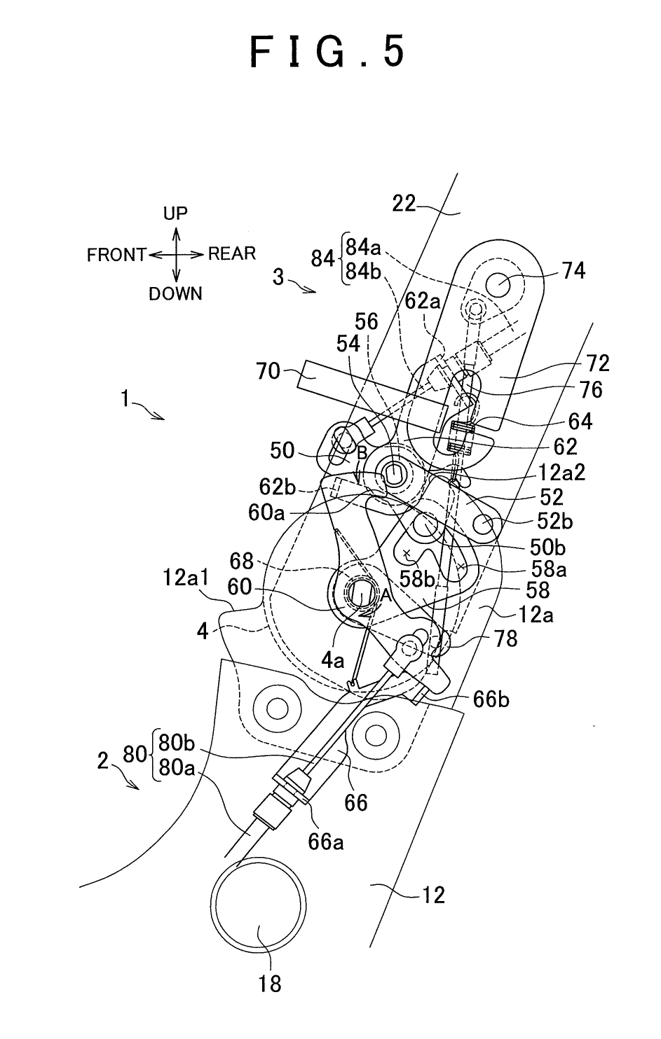

A bracket 66 formed by a first bent-up piece 66a and a second bent-up piece 66b, as shown in FIGS. 4 and 5, is fastened to an outside surface of the left side frame 12. A ratchet 40 of the left recliner 4 is fastened to the inside surface of the lower arm 12a. This is also the same for the right lower arm 14a.

Also, a first stopper 12a1 and a second stopper 12a2 that are able to abut against a positioning spacer 56 of a hinge pin 54 are formed on the outer periphery of the left lower arm 12a. Therefore, the seat back 3 can be restricted from tilting forward or backward too far. This is also the same for the right lower arm 14a.

Also, a slide release link 60 is pivotally attached to an outside surface of the left lower arm 12a via a hinge pin 4a of the left recliner 4. A first operating cable 80 is retained between one end of the slide release link 60 and a slide lock mechanism, not shown. The first operating cable 80 has a double structure that includes an outer cable 80a formed in a cylindrical shape, and an inner cable 80b inside the outer cable 80a.

Also, one end of the outer cable 80a of the first operating cable 80 is fastened to the first bent-up piece 66a of the bracket 66, and the other end is fastened to a bent-up piece (not shown) of a bracket (also not shown) provided near the slide lock mechanism (also not shown). Meanwhile, one end of the inner cable 80b of the first operating cable 80 is fastened to one end of the slide release link 60, and the other end is fastened to a hook (not shown) of the slide lock mechanism (also not shown).

Also, a hook 60a on which a pin 52b of a second cable operating link 52 catches is formed on the other end of the slide release link 60. A torsion spring 68 is strung between the slide release link 60 and the second bent-up piece 66b of the bracket 66 such that, in the normal mode, one end of the slide release link 60 is pushed against the second bent-up piece 66b of the slide release link 60 (i.e., such that the slide release link 60 is urged in the clockwise direction (i.e., the direction of arrow A) in FIG. 5).

The seat cushion 2 structured in this way is mounted to a floor (not shown) via a well-known slide mechanism (also not shown). As a result, the passenger seat 1 is able to be slid forward and backward. Also, a well-known slide lock mechanism that can lock the seat cushion 2 so that it will not slide is assembled to the slide mechanism (not shown). As a result, the slide position of the passenger seat 1 can be adjusted as appropriate.

Next, returning to FIG. 1, the seat back 3 will be described. This seat back 3 also mainly includes a back frame 20, a back pad (not shown) that wraps around this back frame 20, and a cover (not shown) that covers the surface of this back pad.

This back frame 20 is also formed in a general U-shape and includes a left side frame 22, a right side frame 24, and an upper frame 26 that extends between the upper ends of these side frames 22 and 24.

A walk-in lever 82 is pivotally attached to the left side (i.e., a portion corresponding to the shoulder on the left side of the back frame 20) of the upper frame 26. This walk-in lever 82 serves as the first switching portion of the invention. Also, a bracket 28 on which a bent-up piece 28a is formed is fastened to the left side of the upper frame 26. Meanwhile a bracket 62 on which a first bent-up piece 62a and a second bent-up piece 62b are formed is also fastened to the lower side of the left side frame 22.

Also, as shown in FIGS. 4 and 5, a first cable operating link 50 is pivotally attached to the inside surface on the lower side of the left side frame 22, and a second cable operating link 52 is pivotally attached to the outside surface on the lower side of the left side frame 22. More specifically, the cable operating links 50 and 52 are pivotally attached to the lower side of the left side frame 22 in an integrated manner via the hinge pin 54.

A second operating cable 84 is fastened between one end of the first cable operating link 50 and the walk-in lever 82. This second operating cable 84 has a double structure that includes a cylindrical outer cable 84a and an inner cable 84b inside of the outer cable 84a, similar to the first operating cable 80 described above.

Also, one end of the outer cable 84a of the second operating cable 84 is also fastened to the bent-up piece 28a of the bracket 28 described above, and the other end is also fastened to the first bent-up piece 62a of the bracket 62 described above. Meanwhile, one end of the inner cable 84b of the second operating cable 84 is fastened to the walk-in lever 82 described above, and the other end is fastened to one end of the first cable operating link 50 described above.

Further, a pin 50b that moves inside of a first long hole 58a and a second long hole 58b of a recliner release operating plate 58 is formed on the other end of the first cable operating link 50. A tension spring 64 is strung between the first cable operating link 50 and the first bent-up piece 62a of the bracket 62 such that, in the normal mode, one end of the first cable operating link 50 is pushed against the second bent-up piece 62b of the retaining portion 62 (i.e., such that the first cable operating link 50 is urged in the counter clockwise direction (i.e., the direction of arrow B) in FIG. 5).

Meanwhile, a pin 52b that pushes against the slide release link 60 is also formed on the other end of the second cable operating link 52.

Moreover, the recliner release operating plate 58 is fastened to the hinge pin 4a of the left recliner 4 on the inner surface side on the lower side of the left side frame 22. The first long hole 58a is formed in generally the circumferential direction in the recliner release operating plate 58, and the second long hole 58b is formed in generally the radial direction so as to communicate with one end of the first long hole 58a, in the recliner release operating plate 58. The pin 50b of the first cable operating link 50 moves as described above inside of the long holes 58a and 58b.

Also, a fold-down lever 72 that has a strap 70 is pivotally attached via a transfer rod 74 to the outer surface side on the lower side of the left side frame 22. This strap 70 serves as the second switching portion of the invention. This transfer rod 74 is formed extending between the left and right side frames 22 and 24. The transfer rod 74 is pivotally attached so as to enable a recliner transfer rod 6 to rotate via a wire 76 and a recliner release operating link 78, such that the left and right recliners 4 and 5 switch from a locked state to an unlocked state, when an occupant operates the strap 70.

Lastly, the left recliner 4 will be described. This left recliner 4 is well known, and mainly includes a guide 30 that is assembled such that relative rotation is made possible by the housing 42, and the ratchet 40. The outside surface of the guide 30 is fastened to the outside surface of the left side frame, and the outside surface of the ratchet 40 is fastened to the inside surface of the lower arm 12a.

A hinge cam 32 that engages with the hinge pin 4a of the left recliner 4, a slide cam 34 that slides with rotation of this hinge cam 32, and a pair of poles 36 that slide when the slide cam 34 slides are formed inside the guide 30.

Engaging teeth 36a that are able to engage with engaging zones 40a formed on an inner peripheral surface of the ratchet 40 are formed on each of the poles 36. During normal operation, the hinge cam 32 is urged by a spiral spring 38 such that the poles 36 are urged toward the outside. Therefore, during normal operation, the left recliner 4 is able to be locked (i.e., relative rotation of the guide 30 and the ratchet 40 is able to be restricted).

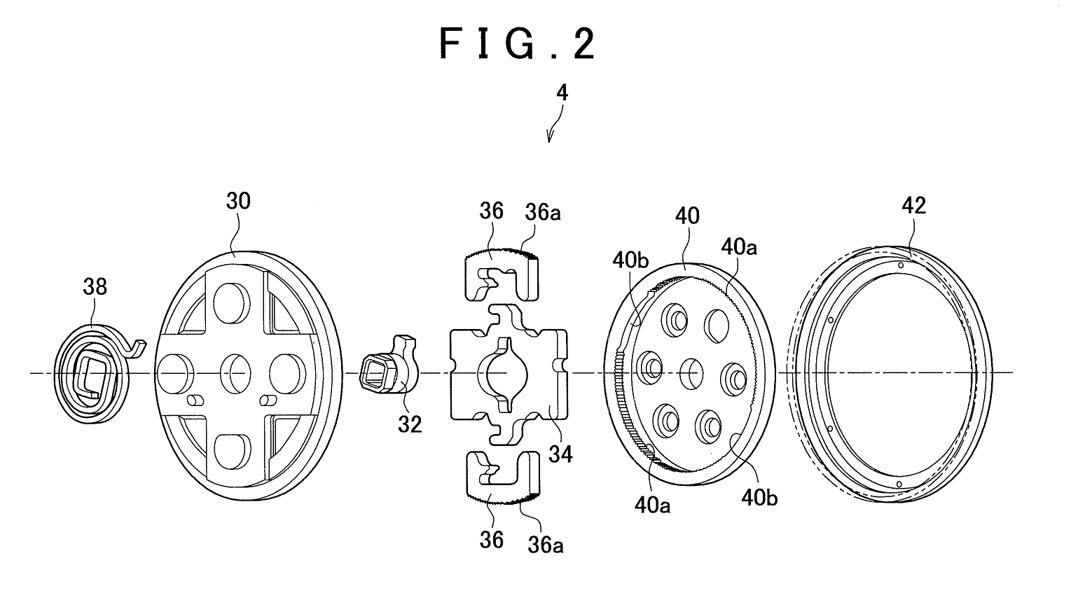

Also, as is also evident from FIG. 2, a pair of free zones 40b are formed on the inner peripheral surface of the ratchet 40. These free zones 40b are framed raised from the engaging zones 40a toward the center of the ratchet 40. Therefore, the left recliner 4 is formed such that when the engaging teeth 36a of the poles 36 reach the free zones 40b as the seat back 3 is tilted forward, rotation of the hinge cam 32 is restricted with respect to the guide 30.

After the engaging teeth 36a of the poles 36 pass the free zones 40b when the seat back 3 is tilted forward even further, the engaging teeth 36a of the poles 36 will become engaged again with the engaging zones 40a of the ratchet 40. The hinge pins 4a and 5a (not shown) of the left and right recliners 4 and 5 are fastened together via the recliner transfer rod 6. As a result, the states (i.e., a locked state or an unlocked state) of the left and right recliners 4 and 5 can be synchronized.

Also, the passenger seat 1 is formed by the seat cushion 2 and the seat back 3, and the seat back 3 is attached to the seat cushion 2 via the left and right recliners 4 and 5. At this time, the seat back 3 is attached to the seat cushion 2 not only by the left and right recliners 4 and 5, but also by a spiral spring (not shown).

Therefore, during normal operation, the seat back 3 can be urged in the forward-tilting direction, so that when the left and right recliners 4 and 5 are unlocked, the seat back 3 can be switched from the normal mode to the walk-in mode or from the normal mode to the luggage mode, using the urging force of this spiral spring.

Continuing on, the operation of the passenger seat 1 will now be described. Below, an operation for switching from the normal mode to the walk-in mode and an operation for switching from the normal mode to the luggage mode will be described separately. Also, in both of these descriptions, in the normal mode, the slide lock mechanism is locked.

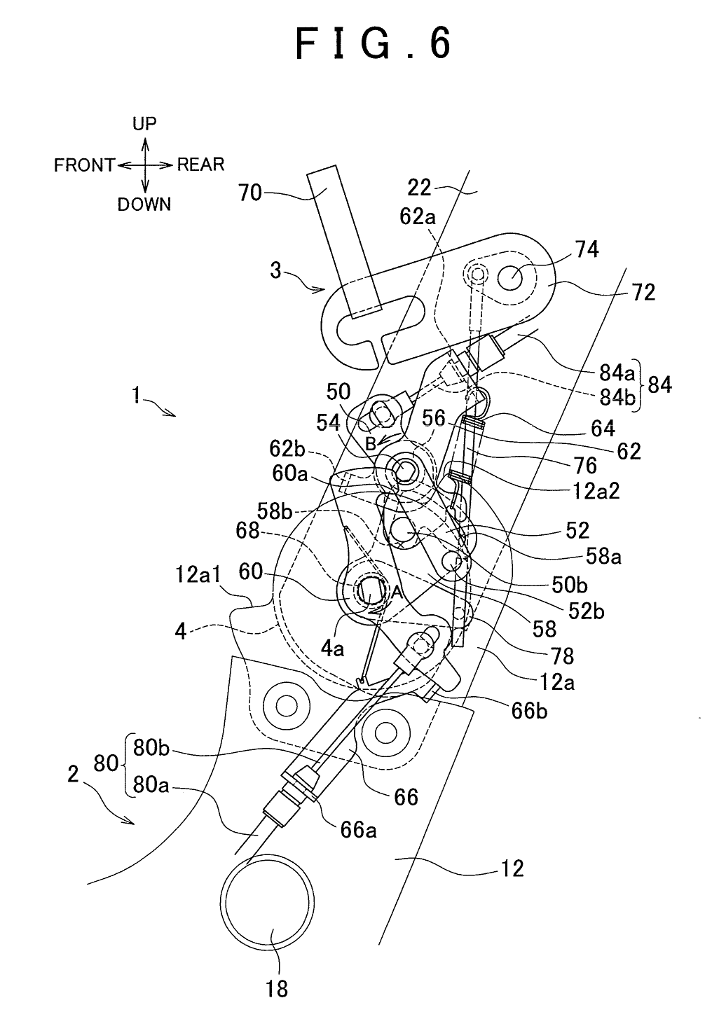

First, the operation for switching from the normal mode to the walk-in mode will be described with reference to FIGS. 3A to 3E and 5 to 8. Initially, from the state shown in FIGS. 3A and 5, when the walk-in lever 82 is operated (the state shown in FIG. 3B), the inner cable 84b of the second operating cable 84 is pulled. As a result, the first cable operating link 50 and the second cable operating link 52 rotate clockwise against the urging force of the tension spring 64, about the axis of the hinge pin 54 (see FIG. 6).

When the first cable operating link 50 rotates in this way, the pin 50b pushes against the inside surface of the second long hole 58b of the recliner release operating plate 58, while sliding into the second long hole 58b, thus enabling the recliner release operating plate 58 to rotate. As a result, the hinge pin 4a of the left recliner 4 also rotates, causing the left recliner 4 to switch from a locked state to an unlocked state.

Also, when the second cable operating link 52 rotates in this way, the pin 52b approaches a position where it is able to abut against the slide release link 60. When the hinge pin 4a of the left recliner 4 rotates, the hinge pin 5a (not shown) of the right recliner 5 also rotates via the recliner transfer rod 6, so the right recliner 5 also switches from a locked state to an unlocked state.

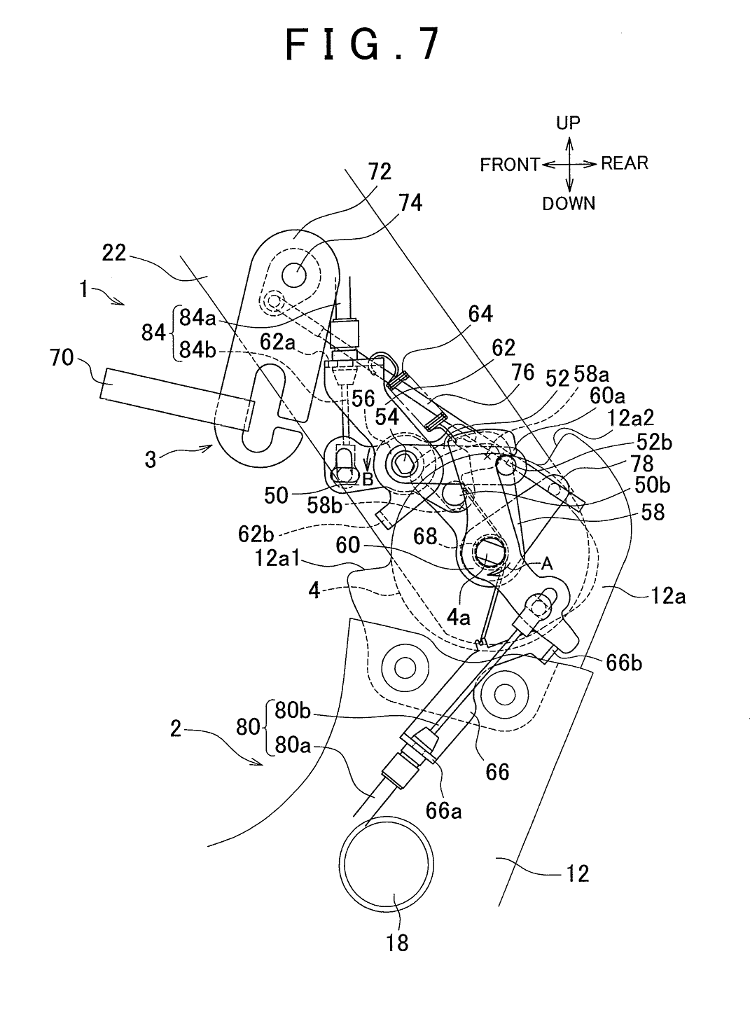

When the left and right recliners 4 and 5 switch from the locked state to the unlocked state in this way, the seat back 3 tilts forward by the urging force of the spiral spring (not shown) as described above (see FIG. 7). That is, the guides 30 in the left and right recliners 4 and 5 rotate with respect to the ratchets 40.

When the engaging teeth 36a of the poles 36 of the left and right recliners 4 and 5 reach the free zones 40b as a result of this rotation, the rotation of the hinge cams 32 becomes restricted with respect to the guides 30, as already described above.

As a result, the recliner release operating plate 58 that is fastened to the left hinge pin 4a engaged with the hinge cam 32 is also restricted from rotating with respect to the left side frame 22, so even if the pin 50b of the first cable operating link 50 that is in the second long hole 58b of the recliner release operating plate 58 tries to return by the return force of the tension spring 64, it is able to be prevented from doing so.

Hence, the left and right recliners 4 and 5 can be kept in unlocked. As a result, the pin 52b of the second cable operating link 52 can be kept close to the position where it can abut against the slide release link 60.

Furthermore, when the seat back 3 is tilted forward, the pin 52b of the second cable operating link 52 starts to push against the slide release link 60. As a result, the slide release link 60 rotates against the urging force of the torsion spring 68, about the axis of the hinge pin 4a of the left recliner 4. At this time, the pushed pin 52b catches on the hook 60a of the slide release link 60, which prevents the pin 52b from being pushed out.

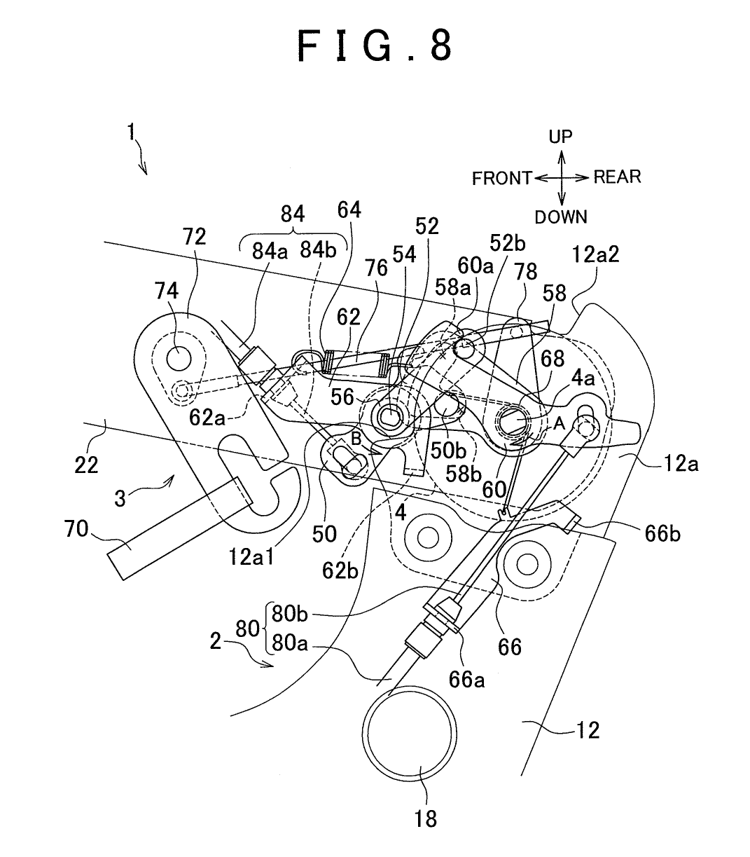

When the slide release link 60 rotates in this way, the inner cable 80b of the first operating cable 80 is pulled, so the slide lock mechanism (not shown) can be switched from a locked state to an unlocked state. The seat back 3 is tilted forward until it comes to be in a folded-down position in which it substantially lies on top of the seat cushion 2 (see FIGS. 3C and 8).

In this folded-down position, the slide release link 60 remains in rotated position, so the tension on the inner cable 80b of the first operating cable 80 is also maintained, which enables the slide lock mechanism (not shown) to remain unlocked. Therefore, in this folded-down position, the passenger seat 1 is able to be slid forward (see FIG. 3D).

Also in this folded-down position, as described above, the recliner release operating plate 58 is restricted from rotating with respect to the left side frame 22, so even if the engaging teeth 36a of the poles 36 reach the engaging zones 40a of the ratchet 40 again in the left and right recliners 4 and 5, the left and right recliners 4 and 5 are able to be kept unlocked.

In this way, the passenger seat 1 is able to be switched from the normal mode to the walk-in mode. In this walk-in mode, as described above, the slide lock mechanism (not shown) is unlocked, so the left and right recliners 4 and 5 are also unlocked. In order to return the passenger seat 1 that has been switched to the walk-in mode to the normal mode, the seat back 3 need simply be raised (see FIG. 3E).

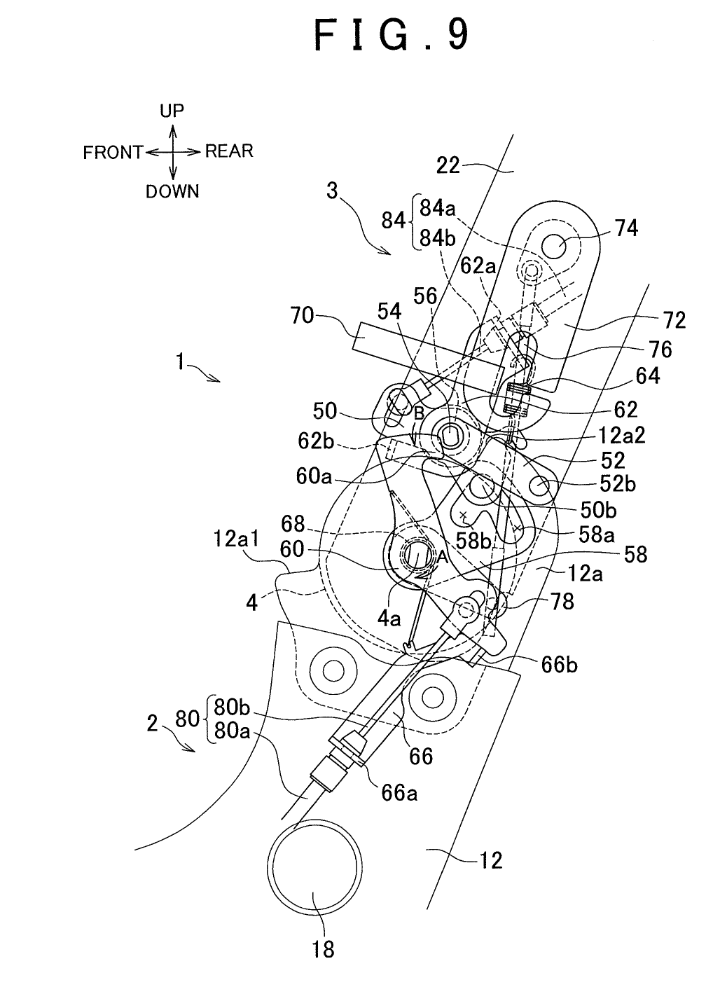

Next, the operation for switching from the normal mode to the luggage mode will be described with reference to FIGS. 3F to 3J and FIGS. 9 to 12. Initially, from the state shown in FIGS. 3F and 9, when the strap 70 is operated (the state shown in FIG. 3G), the fold-down lever 72 consequently is pulled up. As a result, the transfer rod 74 rotates, and this rotation also causes the wire 76 to be pulled up.

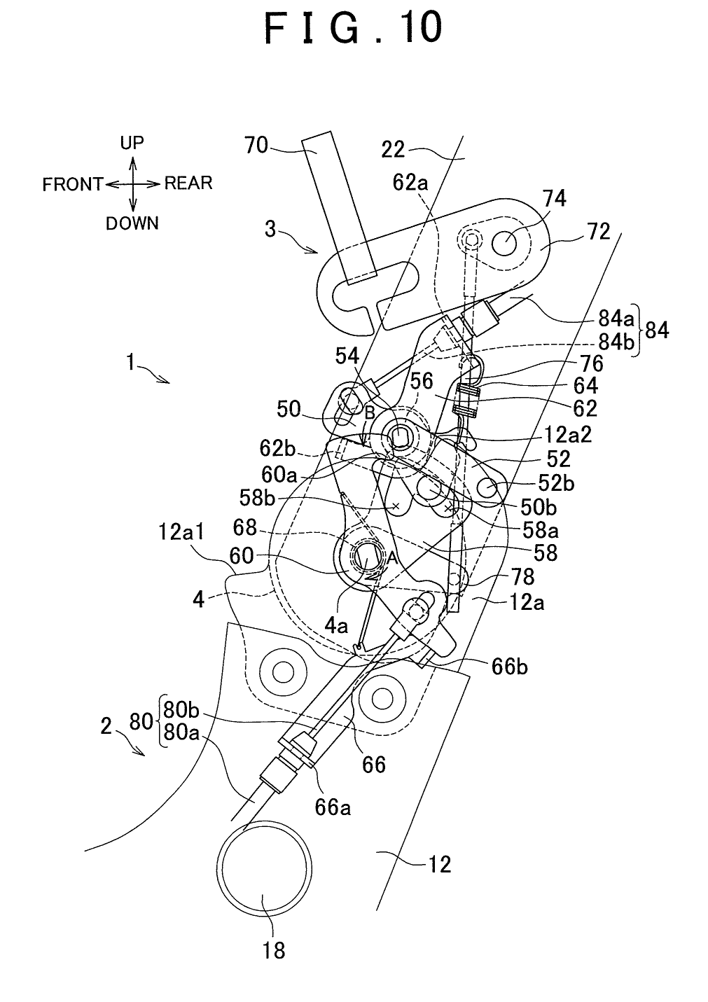

When the wire is pulled up in this way, the recliner release operating link 78 is also pulled up, which enables the recliner transfer rod 6 to be rotated (see FIG. 10). As a result, the hinge pins 4a and 5a (not shown) of the left and right recliners 4 and 5 also rotate, such that the left and right recliners 4 and 5 switch from a locked state to an unlocked state. At this time, the recliner release operating plate 58 also rotates while the pin 50b of the first cable operating link 50 moves inside the first long hole 58a of the recliner release operating plate 58.

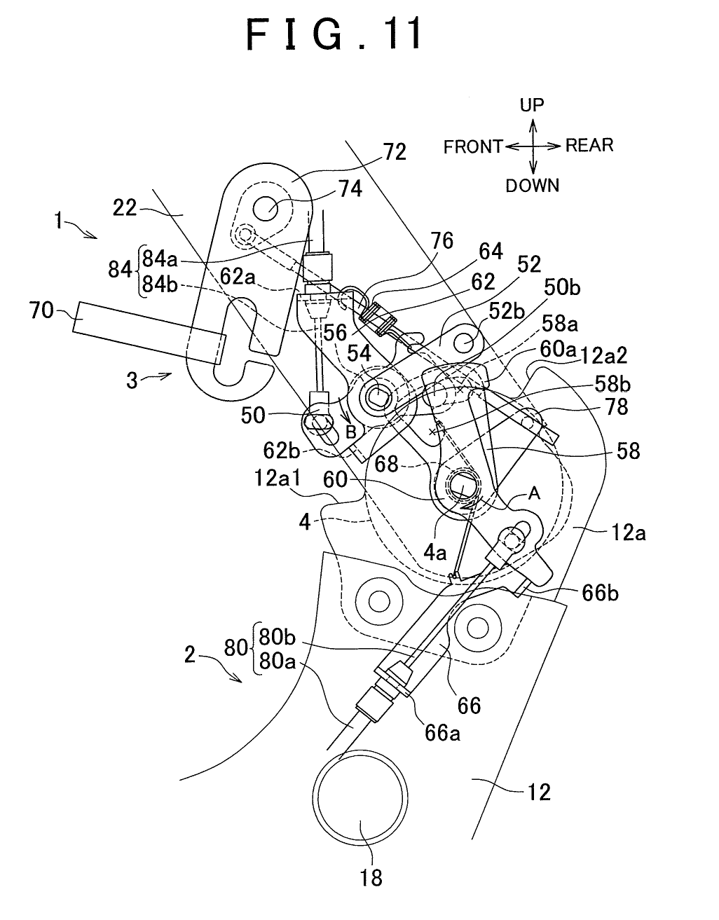

When the left and right recliners 4 and 5 switch from the locked state to the unlocked state in this way, the seat back 3 tilts forward by the urging force of the spiral spring (not shown) as described above (see FIG. 11).

Moreover, when the seat back 3 tilts forward, unlike in the description of the operation for switching from the normal mode to the walk-in mode described above, the pin 52b of the second cable operating link 52 does not approach a position where it can abut against the slide release link 60, so the pin 52b of the second cable operating link 52 does not push against the slide release link 60. Therefore, the slide lock mechanism remains locked.

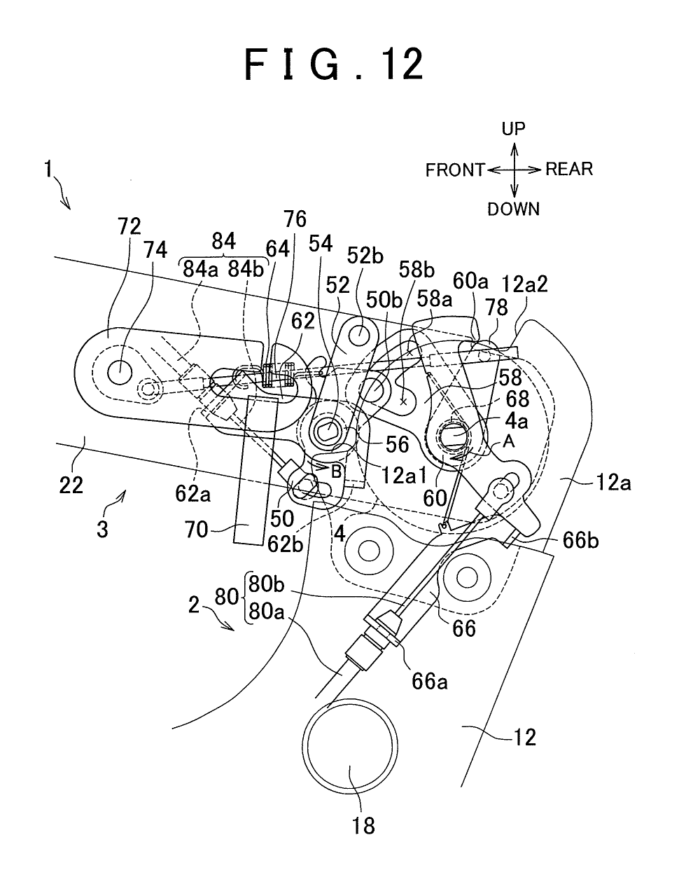

The seat back 3 tilts forward until it comes to be in a folded-down position in which it substantially lies on top of the seat cushion 2 (see FIGS. 3H and 12). When the seat back 3 is in the folded-down position in this way, the engaging teeth 36a of the poles 36 again engage with the engaging zones 40a of the ratchet 40 in the left and right recliners 4 and 5, as described above, so the left and right recliners 4 and 5 are able to be returned to the locked state.

In this way, the passenger seat 1 is able to be switched from the normal mode to the luggage mode. In the luggage mode, the slide lock mechanism (not shown) is locked and the left and right recliners 4 and 5 are also locked, as described above. In order to return the passenger seat 1 that has been switched to the luggage mode to the normal mode, the left and right recliners 4 and 5 need simply be unlocked by operating the strap 70 and the seat back 3 raised.

According to the structure described above, in the walk-in mode, the seat back 3 is in a folded-down position in which it substantially lies on top of the seat cushion 2. Therefore, even if a person that is seated, or will be seated, in the rear seat is large, the seat back 3 is less apt to get in the way when the person gets into and out of the rear seat. Accordingly, a person is able to get into and out of the rear seat with greater ease.

Also, the passenger seat 1 can be switched from the normal mode to the walk-in mode by operating the walk-in lever 82. In this walk-in mode, the left and right recliners 4 and 5 are kept unlocked. On the other hand, the passenger seat 1 can be switched from the normal mode to the luggage mode by operating the strap 70. In this luggage mode, the left and right recliners 4 and 5 are again locked. That is, when returning the folded-down seat back to the normal mode when switching in the walk-in mode, the seat back 3 does not need to be unlocked with respect to the seat cushion 2 (i.e., the left and right recliners 4 and 5 do not need to be unlocked). Therefore, the seat back can be returned easily.

Also, according to this structure, it is possible to select the walk-in mode in which the seat slide is unlocked, and the luggage mode in which the seat slide is locked. Therefore, the occupant can select either the walk-in mode or the luggage mode depending on the intended use.

Also, according to this structure, operating the walk-in lever 82 makes it possible to switch the seat back 3 to the folded-down position in the walk-in mode in which the seat slide is unlocked, while operating the strap 70 makes it possible to switch the seat back 3 to the folded-down position in the luggage mode in which the seat slide is locked. Therefore, usability of the vehicle seat can be further improved by selecting the walk-in mode to quickly return the seat back 3.

Also, according to this structure, in the walk-in mode, operation of the walk-in lever 82 causes the first cable operating link 50 and the second cable operating link 52 to rotate. The rotated first cable operating link 50 in turn causes the recliner release operating plate 58 to also rotate, and the rotation of the recliner release operating plate 58 switches the left and right recliners 4 and 5 from a locked state to an unlocked state. When the seat back 3 tilts forward as a result of this switch, it causes the slide release link 60 to rotate, and this rotated slide release link 60 switches the slide lock mechanism from a locked state to an unlocked state. In the luggage mode, operation of the strap 70 causes the recliner release operating plate 58 to rotate, and the rotation of the recliner release operating plate 58 switches the recliners 4 and 5 from a locked state to an unlocked state. Even if the seat back 3 tilts forward as a result of this switch, the slide lock mechanism will remain locked. Thus, a vehicle seat that further increases the ease with which a person is able to get into and out of the rear seat, and a vehicle seat that makes it easy to return a seat back, even when returning a seat back that has been folded down, to a normal mode, can be provided by a simple structure.

The description above relates only to one example embodiment of the invention. The invention is not intended to be limited in any way to this description. In the example embodiment, the passenger seat 1 when there is a rear seat is described as an example of the vehicle seat. However, the invention is not limited to this. For example, the vehicle seat may also be a driver seat when there is a rear seat, or a second row seat when there is a third row seat.

What is claimed is:

1. A vehicle seat which is provided with a recliner and a slide lock mechanism, and in which a seat back is tilted forward from a normal mode in which a person is seated to a walk-in mode in which a person gets into and out of a rear seat,
wherein in the walk-in mode, the seat back is in a folded-down position in which the seat back substantially lies on top of a seat cushion.

2. The vehicle seat according, to claim 1, wherein the vehicle seat is configured to enable the walk-in mode in which a seat slide is unlocked, and a luggage mode in which the seat slide is locked, to be selected.

3. The vehicle seat according to claim 2, comprising:
a first switching portion;
a second switching portion;
a first cable operating link;
a second cable operating link;
a recliner release operating plate; and
a slide release link,
wherein in the walk-in mode, operation of the first switching portion causes the first cable operating link and the second operating link to rotate, and the rotation of the first cable operating link causes the recliner release operating plate to also rotate, and the rotation of this recliner release operating plate switches the recliner from a locked state to an unlocked state, and when the recliner is unlocked and the seat back tilts forward, the slide release link rotates in conjunction with the forward tilting of the seat back, and the rotation of the slide release link switches the slide lock mechanism from a locked state to an unlocked state; and in the luggage mode, operation of the second switching portion causes the recliner release operating plate to rotate, and the rotation of the recliner release operating plate switches the recliner from a locked state to an unlocked state, and when the recliner is unlocked and the seat back tilts forward, the slide lock mechanism remains locked.

4. A vehicle seat which is provided with a recliner and a slide lock mechanism, and in which a seat back is switched from a normal mode in which a person is able to be seated to a mode in which the seat back is in a folded-down position in which the seat back substantially lies on top of a seat cushion, comprising:
a first switching portion; and
a second switching portion,
wherein if a switching operation of either one of the switching portions is performed, the recliner will unlock and the seat back will switch from the normal mode to the mode in which the seat back is in a folded-down position; and when the first switching portion is operated and the seat back switches from the normal mode to the mode in which the seat back is in a folded-down position, the recliner remains unlocked; and when the second switching portion is operated and the seat back switches from the normal mode to the mode in which the seat back is in a folded-down position, the recliner is locked.

5. The vehicle seat according to claim 4, wherein operation of the first switching portion causes the seat back to switch to the folded-down position in the walk-in mode in which a seat slide is unlocked; and operation of the second switching portion causes the seat back to switch to the folded-down position in a luggage mode in which the seat slide is locked.

6. The vehicle seat according to claim 4, further comprising:
a first cable operating link;
a second cable operating link;
a recliner release operating plate; and
a slide release link,
wherein in the walk-in mode, operation of the first switching portion causes the first cable operating link and the second operating link to rotate, and the rotation of the first cable operating link causes the recliner release operating plate to also rotate, and the rotation of this recliner release operating plate switches the recliner from a locked state to an unlocked state, and when the recliner is unlocked and the seat back tilts forward, the slide release link rotates in conjunction with the forward tilting of the seat back, and the rotation of the slide release link switches the slide lock mechanism from a locked state to an unlocked state; and in the luggage mode, operation of the second switching portion causes the recliner release operating plate to rotate, and the rotation of the recliner release operating plate switches the recliner from a locked state to an unlocked state, and when the recliner is unlocked and the seat back tilts forward, the slide lock mechanism remains locked.
